(19) United States
(12) Patent Application Publication
(10) Pub. No.: US 2025/0229158 A1
(43) Pub. Date: Jul. 17, 2025

(54) GOLF SUPPORT SYSTEM AND COMPUTER READABLE MEDIUM

(71) Applicant: Mitsubishi Electric Corporation, Tokyo (JP)

(72) Inventor: Tadashi OZAWA, Tokyo (JP)

(73) Assignee: Mitsubishi Electric Corporation, Tokyo (JP)

(21) Appl. No.: 18/848,544

(22) PCT Filed: Mar. 25, 2022
(86) PCT No.: PCT/JP2022/014698

§ 371 Date: Sep. 19, 2024

(51) Int. Cl. A63B 71/06; A63B 55/60; A63B 69/36; G05D 1/689; G05D 105/60; G05D 107/20; G05D 109/20

(52) U.S. Cl. CPC A63B 71/0622; A63B 55/61; G05D 1/689; A63B 69/3691; A63B 2071/0691; A63B 2220/05; A63B 2220/13; A63B 2220/807; G05D 2105/60; G05D 2107/24; G05D 2109/20

(57) ABSTRACT

A golf support system supports a user to play golf on a golf course. The golf support system includes a course travelling vehicle to be operated in the golf course. A photographing unit photographs a trajectory of a golf ball as a trajectory image by using a camera mounted on the course travelling vehicle. A trajectory prediction unit calculates the trajectory of the golf ball as a predicted trajectory by using the trajectory image. A route calculation unit calculates a predicted drop position being a drop position of the golf ball by using the predicted trajectory. Then, the route calculation unit calculates a travelling route to the predicted drop position of the golf ball.

### TECHNICAL FIELD

The present disclosure relates to a golf support system, a moving body, a server device, a golf support method and a golf support program. Especially, the present disclosure relates to a golf support system, a moving body, a server device, a golf support method and a golf support program to support a user being a golfer playing golf on a golf course.

### BACKGROUND ART

As a vehicle used on a golf course, there exists a golf cart to load golf bags for all golfers playing golf, and travels in a cart road or a travelable area inside the golf course.

Further, in recent years, a robot caddie to load a golf bag of one golfer inside a golf course, and to move following the golfer is beginning to be introduced.

Patent Literature 1 discloses an autonomous vehicle that loads a golf bag of a golfer, and moves following the golfer by receiving signals from a remote transmitter carried by the golfer. Further, Patent Literature 1 discloses a technique to make the autonomous vehicle travel safely, and a technique to present beneficent information for the golfer by using the autonomous vehicle.

### CITATION LIST

### Patent Literature

Patent Literature 1: JP 6841835 B2

### SUMMARY OF INVENTION

### Technical Problem

In playing golf on a golf course, it has been a manner to progress at an appropriate pace. Therefore, when a ball hit by a golfer cannot be found, the time to find the ball may be shortened, and it may result in lost ball. Further, it may take too much time than expected for a golfer to find a ball, and the entire progress may be delayed.

As described, it has been a problem for both of golfers and golf courses to smoothly and accurately find a ball in playing golf in the golf courses.

However, in the technique in Patent Literature 1, support in moving following a golfer is conducted; however, Patent Literature 1 does not disclose support in finding a ball.

The present disclosure is aimed at performing search for and identification of a golf ball smoothly and accurately, reducing the load on a user in finding a ball, and providing a comfortable playing experience, by using various moving bodies operated on a golf course.

### Solution to Problem

There is provided according to one aspect of the present disclosure a golf support system to support a user to play golf on a golf course, and to include a moving body to be operated in the golf course, the golf support system includes:
a photographing unit to photograph a trajectory of a golf ball hit by the user, by using a camera mounted on the moving body, as a trajectory image;
a trajectory prediction unit to calculate the trajectory of the golf ball by using the trajectory image, as a predicted trajectory; and
a route calculation unit to calculate a predicted drop position being a drop position of the golf ball by using the predicted trajectory, and to calculate a moving route of the moving body to the predicted drop position.

### Advantageous Effects of Invention

By a golf support system according to the present disclosure, it is possible to reduce the load on a user in finding a ball, and to provide a comfortable playing experience, by using an image photographed by a moving body operated on a golf course, and performing search for and identification of a golf ball smoothly and accurately.

### BRIEF DESCRIPTION OF DRAWINGS

FIG. 1 is a diagram illustrating an example of an overall configuration of a golf support system according to a first embodiment;

FIG. 2 is a diagram illustrating a configuration example of a course travelling vehicle according to the first embodiment;

FIG. 3 is a diagram illustrating a configuration example of a server device according to the first embodiment;

FIG. 4 is a diagram illustrating a configuration example of the course travelling vehicle according to the first embodiment;

FIG. 5 is a flow diagram illustrating an operation of the golf support system according to the first embodiment;

FIG. 6 is a diagram illustrating a situation of photographing a shot of a user according to the first embodiment;

FIG. 7 is a diagram illustrating a display example of a predicted trajectory image according to the first embodiment;

FIG. 8 is a diagram illustrating a diagram illustrating a situation of photographing by a drone 300 according to the first embodiment;

FIG. 9 is a flow diagram illustrating a drafting process of a search result 57 of a golf ball by a ball search unit 230 according to the first embodiment;

FIG. 10 is a diagram illustrating a configuration example of a server device 200 according to a variation of the first embodiment;

FIG. 11 is a diagram illustrating a configuration example of the course travelling vehicle 100 according to a variation of the first embodiment;

FIG. 12 is a diagram illustrating a configuration example of the server device 200 according to a second embodiment;

FIG. 13 is a diagram illustrating a configuration example of the course travelling vehicle 100 according to the second embodiment;

FIG. 14 is a diagram illustrating an example of a shot image 59 according to the second embodiment; and

FIG. 15 is a diagram illustrating another example of the shot image 59 according to the second embodiment.

### DESCRIPTION OF EMBODIMENTS

Hereinafter, description will be made on present embodiments using diagrams. In drawings, the same or the corresponding elements are denoted by the same reference signs. In description of the embodiments, explanation of the same or the corresponding elements is appropriately omitted or simplified. The arrows in the diagrams mainly represent flows of data or processing. Further, in the diagrams below, the relation between the size of each component may be different from that of actual components. In addition, in the description of the embodiments, orientations or positions such as top, bottom, left, right, before, behind, front or back may be indicated. These representations are description for convenience of explanation, and do not limit the layout, directions and orientations of devices, apparatuses, parts or the like.

### First Embodiment

### ***Description of Configuration***

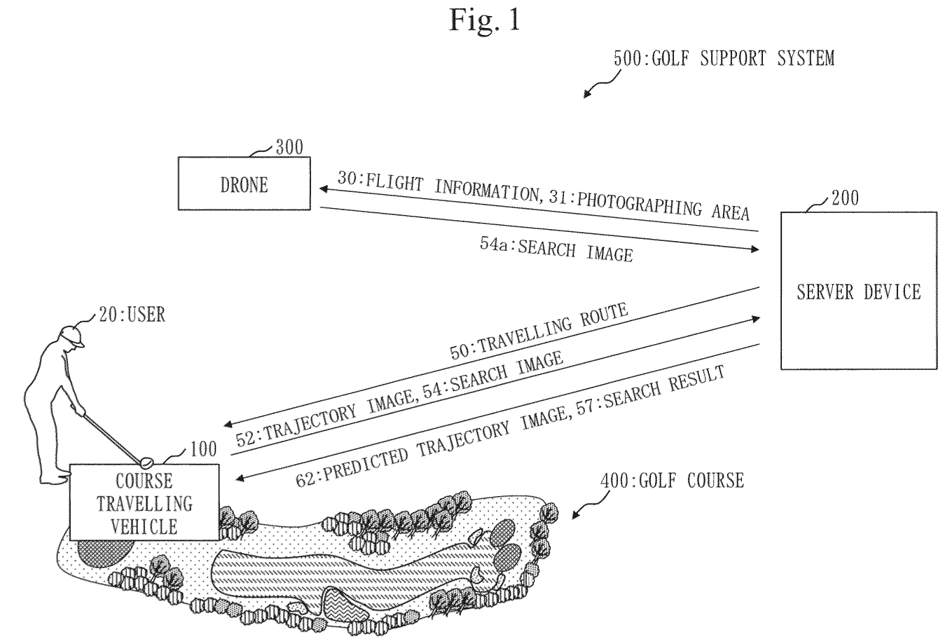

FIG. 1 is a diagram illustrating an example of an overall configuration of a golf support system 500 according to the present embodiment.

The golf support system 500 is a system to support a user 20 who plays golf on a golf course 400. The user 20 is also called a golfer or a player playing golf on the golf course 400.

The golf support system 500 includes a course travelling vehicle 100 and a server device 200. Further, the golf support system 500 may include a drone 300 which autonomously flies over the golf course.

The course travelling vehicle 100 automatically drives on a golf course based on a travelling route 50. Automatic driving is also called autonomous travelling or autonomous movement. The course travelling vehicle 100 communicates with the server device 200 via a network.

The server device 200 is realized by a cloud computer, for example. The server device 200 communicates with the course travelling vehicle 100 via a network.

The drone 300 autonomously flies above the golf course based on flight information 30 transmitted from the server device 200. Autonomous flight is also called autonomous movement. The drone 300 is an example of an autonomous flying object. The drone 300 communicates with the server device 200 via a network.

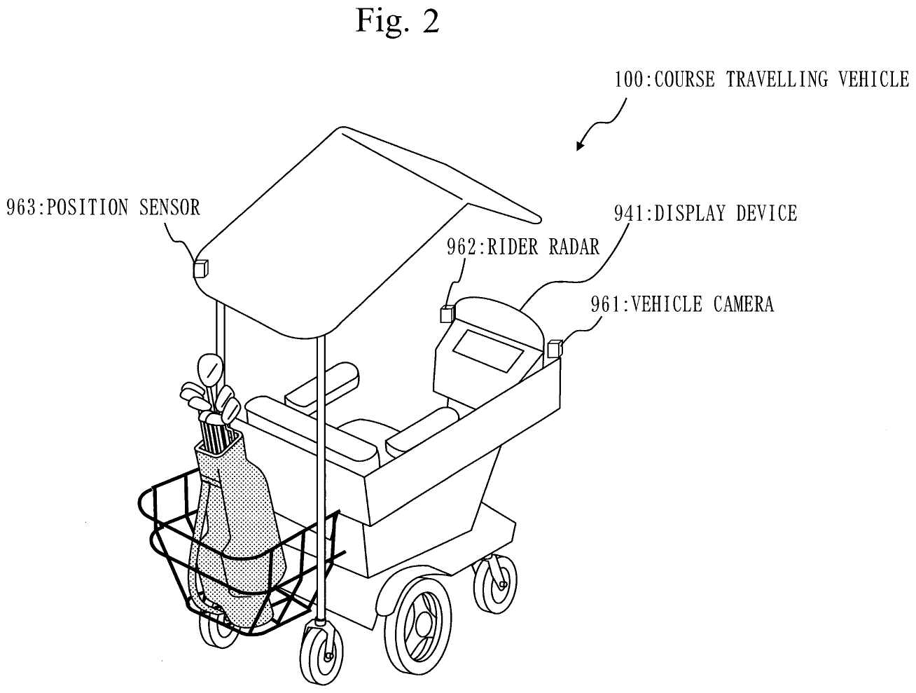

FIG. 2 is a diagram illustrating a configuration example of the course travelling vehicle 100 according to the present embodiment.

The course travelling vehicle 100 is an example of a moving body operated in the golf course.

The course travelling vehicle 100 is an autonomous vehicle to load a golf bag of the user 20 playing golf on the golf course, and automatically drive in the golf course following the travelling route 50 transmitted from the server device 200.

The course travelling vehicle 100 is equipped with apparatuses such as a display device 941, a vehicle camera 961, a rider radar 962 and a position sensor 963.

Further, the course travelling vehicle 100 is equipped with an automatic driving system to perform automatic driving following the travelling route 50. The travelling route 50 is an example of a moving route along which the moving body moves.

The vehicle camera 961 is a camera to photograph the surroundings of the course travelling vehicle 100. The vehicle camera 961 is an example of a camera mounted on the moving body.

For example, the vehicle camera 961 performs photographing of a trajectory of a golf ball, photographing of a state of a user playing golf, photographing to detect an obstacle, photographing to measure a distance to an object, or the like.

The vehicle camera 961 may be configured by a plurality of cameras such as a camera to photograph a trajectory of a golf ball, and a camera to photograph a state of the user playing golf. Further, the vehicle camera 961 may be configured by a plurality of types of cameras such as a normal camera and an omnidirectional camera.

The rider radar 962 detects a distance to a surrounding object of the course travelling vehicle 100. There may be mounted a plurality of rider radars 962. It is possible to detect the condition of the surroundings of the course travelling vehicle 100 more precisely by analyzing the distance information by the rider radar 962 and the image photographed by the vehicle camera 961 together. There is an effect that it becomes possible to precisely detect information such as the trajectory of the golf ball or the distance to the obstacle in the golf course, for example, by using the rider radar 962.

Further, it is also possible to measure data of a course shape by the rider radar 962 mounted on the course travelling vehicle 100 as well, and to update course shape data obtained in advance.

The position sensor 963 obtains position information of the course travelling vehicle 100. More specifically, the position sensor 963 obtains position and time of the course travelling vehicle 100 at the time of moving as position information. The position sensor 963 is, for example, a GPS. GPS is an abbreviation for Global Positioning System.

The automatic driving system is configured by a communication device, a movement control unit and a display device, for example. The movement control unit performs control over movement of a moving body. Specifically, the movement control unit performs control over automatic driving of the course travelling vehicle 100.

The course travelling vehicle 100 is a PMV allowing a person to ride therein and to travel, for example. PMV is an abbreviation for Personal Mobility Vehicle. Further, in a case of a usage form that does not allow a person to ride therein, the course travelling vehicle 100 may be an AMR. AMR is an abbreviation for Autonomous Mobile Robot.

The course travelling vehicle 100 according to the present embodiment has a seat whereon a person rides, and is capable of automatically travelling while the user is seated, like a golf cart on a golf course. Since it is possible for the user to ride on the and move with the vehicle, there is an effect that the play time can be shortened than in a case of walking.

The course travelling vehicle 100 is capable of automatic driving even when the user is not seated. For example, it may be possible to switch between an automatic driving mode in a state in which the user is seated, and an automatic driving mode in a state in which the user is not seated, by remote control and the like. When the user desires to play golf while walking the golf course, the user can select the automatic driving mode in the state in which the user is not seated.

Further, the course travelling vehicle 100 can switch between an automatic driving mode and a manual driving mode.

Switching between the modes described above in the course travelling vehicle 100 may be performed by a switching button or the like of the main body of the vehicle, or may be performed by remote control or the like.

Further, the course travelling vehicle 100 may include a function such as sound recognition to recognize sounds of the user, or gesture recognition to recognize movements of the user. By this function, the course travelling vehicle 100 can operate several types of functions by sounds or gestures of the user. In this manner, there is an effect that it is possible to reduce the workload on the user, and to realize a more comfortable playing experience.

Further, the course travelling vehicle 100 may include a function to travel at the minimum speed in a front direction inside a fairway when the course travelling vehicle 100 moves to the fairway, and continues to be in a stopping state for a fixed time. Since the user can search for a ball for three minutes in the golf rule, the fixed time can be set arbitrarily to equal to or longer than three minutes of stopping.

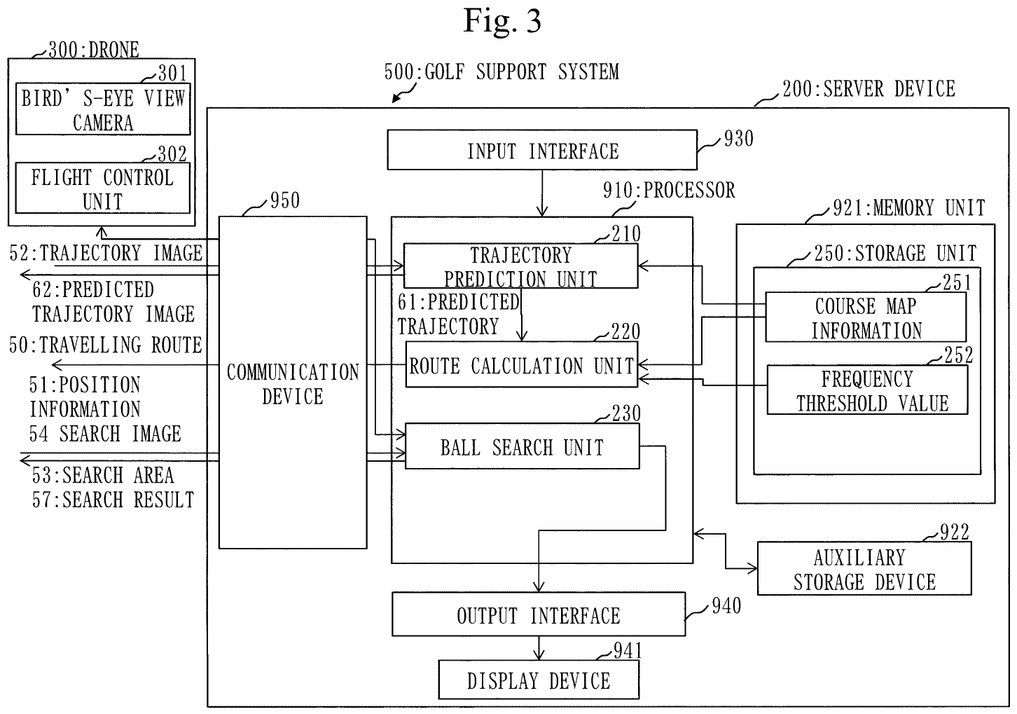

FIG. 3 is a diagram illustrating a configuration example of the server device 200 according to the present embodiment.

The server device 200 is a computer. The server device 200 includes a processor 910, and further includes other hardware components such as a memory unit 921, an auxiliary storage device 922, an input interface 930, an output interface 940 and a communication device 950. The processor 910 is connected to the other hardware components via signal lines or wireless connection, and controls these other hardware components.

The server device 200 includes, as functional elements, a trajectory prediction unit 210, a route calculation unit 220, a ball search unit 230 and a storage unit 250. The storage unit 250 stores course map information 251 and a frequency threshold value 252.

The functions of the trajectory prediction unit 210, the route calculation unit 220 and the ball search unit 230 are realized by software. The storage unit 250 is provided in the memory unit 921. The storage unit 250 may be provided in the auxiliary storage device 922, or may be dispersedly provided in the memory unit 921 and the auxiliary storage device 922.

The processor 910 is a device to execute a golf support program. The golf support program is a program to realize the functions of the trajectory prediction unit 210, the route calculation unit 220 and the ball search unit 230. Further, the golf support program also includes a program to be executed in realizing the function of the course travelling vehicle 100 to be described below.

The processor 910 is an IC to perform arithmetic processing. A concrete example of the processor 910 is a CPU, a DSP or a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory unit 921 is a storage device to temporarily store data. A concrete example of the memory unit 921 is an SRAM or a DRAM. SRAM is an abbreviation for Static Random Access Memory. DRAM is an abbreviation for Dynamic Random Access Memory.

The auxiliary storage device 922 is a storage device to store data. A concrete example of the auxiliary storage device 922 is an HDD. Further, the auxiliary storage device 922 may be a portable storage medium such as an SD (registered trademark) memory card, a CF, a NAND flash, a flexible disk, an optical disk, a compact disk, a Blue-ray (registered trademark) disk, or a DVD. HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port connected to an input device such as a mouse, a keyboard or a touch panel. The input interface 930 is a USB terminal, for example. The input interface 930 may be a LAN interface or Bluetooth (registered trademark). USB is an abbreviation for Universal Serial Bus. LAN is an abbreviation for Local Area Network.

The output interface 940 is a port connected to a cable of an output device such as a display. Further, the output interface 940 may be a LAN interface or Bluetooth (registered trademark). The output interface 940 is, for example, a USB terminal or an HDMI (registered trademark) terminal. The display is, for example, an LCD. The output interface 940 is also called an indicator interface. HDMI (registered trademark) is an abbreviation for High Definition Multimedia Interface. LCD is an abbreviation for Liquid Crystal Display.

The communication device 950 includes a receiver and a transmitter. The communication device 950 is connected to a communication network such as Wi-Fi (registered trademark), a LAN, the Internet or a telephone line. The communication device 950 is, for example, a communication chip or an NIC. NIC is an abbreviation for Network Interface Card.

The golf support program is executed by the server device 200. The golf support program is read into the processor 910, and is executed by the processor 910. The memory unit 921 stores not only the golf support program but also an OS. OS is an abbreviation for Operating System. The processor 910 executes the golf support program while executing the OS. The golf support program and the OS may be stored in the auxiliary storage device 922. The golf support program and the OS stored in the auxiliary storage device 922 are loaded into the memory unit 921, and executed by the processor 910. A part or the whole of the golf support program may be incorporated in the OS.

The server device 200 may include a plurality of processors to replace the processor 910. The plurality of processors share execution of the golf support program. Each processor is a device to execute the golf support program in the same way as the processor 910.

The data, information, signal values and variable values used, processed or output by the golf support program are stored in the memory unit 921, the auxiliary storage device 922 or a register or a cache memory device inside the processor 910.

“Unit” of each unit of the trajectory prediction unit 210, the route calculation unit 220 and the ball search unit 230 may be replaced with “circuit”, “step”, “procedure”, “process” or “circuitry”. The golf support program causes a computer to execute a trajectory prediction process, a route calculation process and a ball search process. The “process” of the trajectory prediction process, the route calculation process and the ball search process may be replaced with “program”, “program product”, “a computer-readable storage medium in which a program is stored” or “a computer-readable recording medium in which a program is recorded”. Further, a golf support method is a method performed by executing the golf support program by the server device 200.

The golf support program may be provided by being stored in a computer-readable recording medium. Further, the golf support program may be provided as a program product.

The server device 200 communicates with the drone 300 via the communication device 950.

The drone 300 is an autonomous flying object equipped with a bird's-eye view camera 301 to photograph the golf course from the above. The drone 300 autonomously flies above the golf course by a flight control unit 302 based on flight information 30 transmitted from the server device 200.

Various types of information exchanged in the server device 200 will be described below.

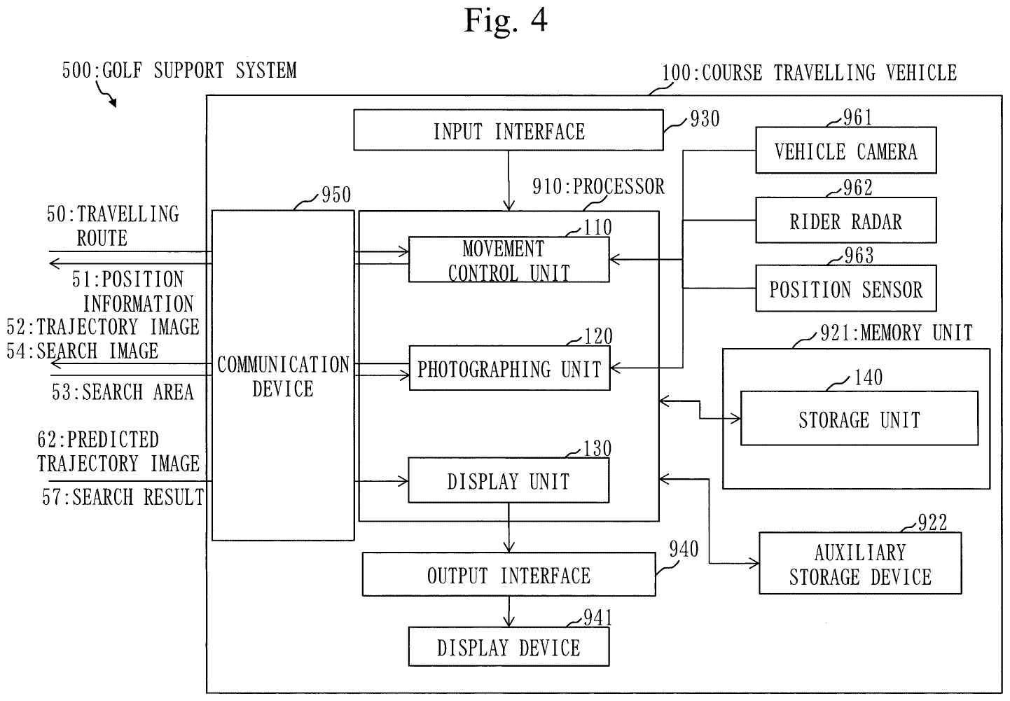

FIG. 4 is a diagram illustrating a configuration example of the course travelling vehicle 100 according to the present embodiment.

The course travelling vehicle 100 is equipped with a computer. The course travelling vehicle 100 includes the processor 910, and further includes other hardware components such as the memory unit 921, the auxiliary storage device 922, the input interface 930, the output interface 940 and the communication device 950. Further, the course travelling vehicle 100 also includes other hardware components such as the vehicle camera 961, the rider radar 962 and the position sensor 963, as described above. The processor 910 is connected to the other hardware components by signal lines or wireless connection, and controls the other hardware components.

Description will be made by adding the same reference signs to the hardware components including functions similar to those of the server device 200 for ease of explanation. However, it is apparent that each of the course travelling vehicle 100 and the server device 200 is equipped with hardware components separately.

The course travelling vehicle 100 includes, as functional elements, the movement control unit 110, the photographing unit 120, the display unit 130 and the storage unit 140.

The functions of the movement control unit 110, the photographing unit 120 and the display unit 130 are realized by software. The storage unit 140 is provided in the memory unit 921. The storage unit 140 may be provided in the auxiliary storage device 922, or may be dispersedly provided in the memory unit 921 and the auxiliary storage device 922.

The processor 910 is a device to execute the golf support program. The golf support program is a program to realize the functions of the movement control unit 110, the photographing unit 120 and the display unit 130. Further, the golf support program also includes a program to be executed at the time when the functions of the server device 200 are realized, as described above.

Description of each hardware component is the same as what described for the server device 200.

“Unit” of each unit of the movement control unit 110, the photographing unit 120 and the display unit 130 may be replaced with “circuit”, “step”, “procedure”, “process” or “circuitry”. The golf support program causes a computer to execute a movement control process, a photographing process and a display process. “Process” of the movement control process, the photographing process and the display process may be replaced with “program”, “program product”, “computer-readable storage medium in which a program is stored” or “computer-readable recording medium in which a program is recorded”.

Various types of information exchanged in the course travelling vehicle 100 will be described below.

### ***Description of Operation***

Next, description will be made on an operation of the golf support system 500 according to the present embodiment. The operation procedure of the golf support system 500 corresponds to a golf support method. Further, a program to realize the operation of the golf support system 500 corresponds to a golf support program.

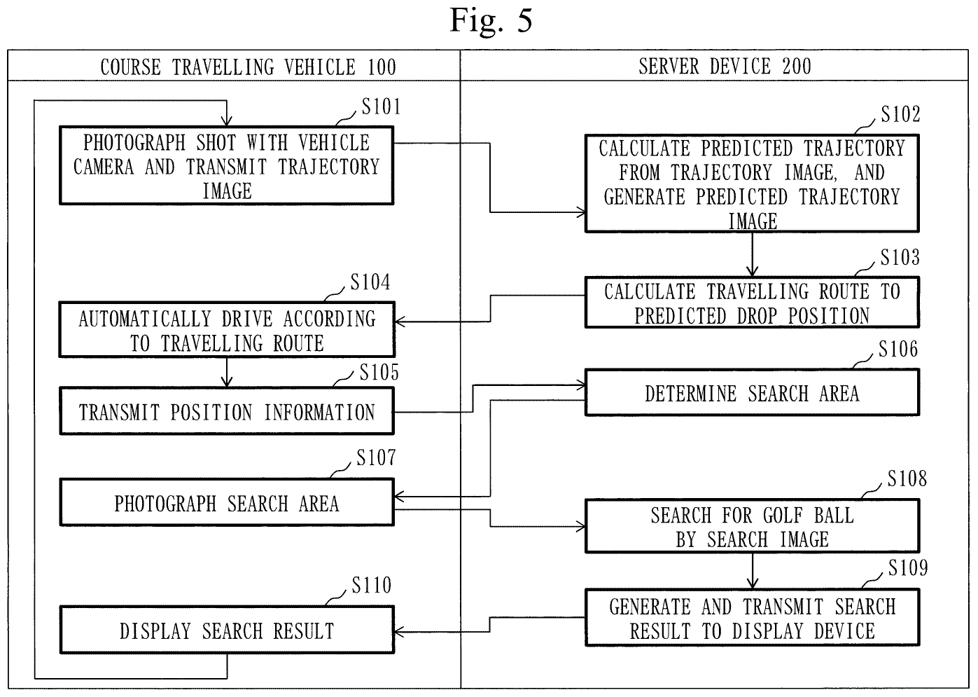

FIG. 5 is a flow diagram illustrating the operation of the golf support system 500 according to the present embodiment.

First, the photographing unit 120 of the course travelling vehicle 100 performs registration of the user 20 before travelling in the course. The photographing unit 120 registers information such as a face, a sound, clothes (color), a gesture and a skeleton-based action pattern (registered trademark) of the user 20. The registered data of the user 20 is retained in both of the course travelling vehicle 100 and the server device 200.

### <Photographing Process: Step S101>

In Step S101, the photographing unit 120 of the course travelling vehicle 100 photographs a trajectory of a golf ball hit by the user 20 by using the vehicle camera 961 mounted on the course travelling vehicle 100, as a trajectory image 52. Then, the photographing unit 120 transmits the trajectory image 52 to the server device 200. The photographing unit 120 attaches rider radar data corresponding to the trajectory image 52 to the trajectory image 52, and transmits the trajectory image 52 to the server device 200.

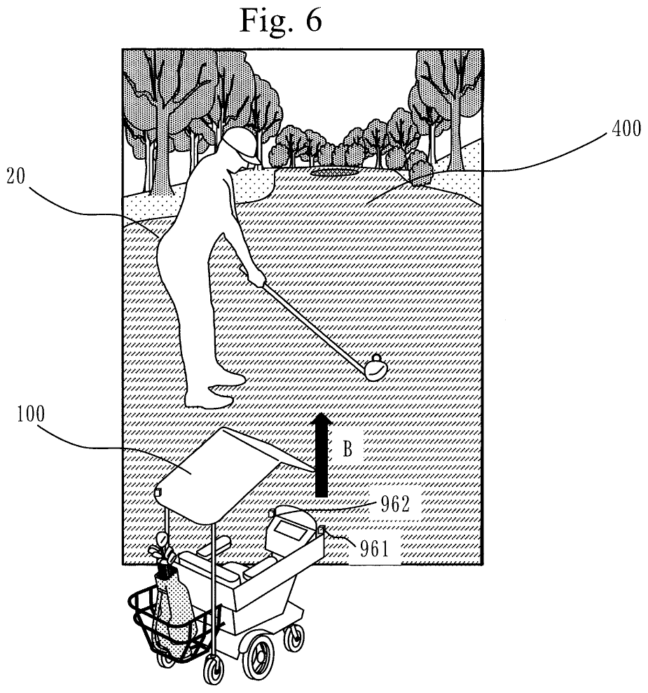

FIG. 6 is a diagram illustrating a situation of photographing a user at the start of a shot according to the present embodiment.

The photographing unit 120 starts photographing according to a photographing request by the user 20, and finishes photographing according to a photographing finish request by the user 20.

Otherwise, the photographing unit 120 may decide when to start or finish photographing automatically. For example, the photographing unit 120 detects a posture of the user 20 at the start of a shot, and, causes the vehicle camera 961 to start photographing of a trajectory of a golf ball based on detection of the posture at the start of the shot. Further, the photographing unit 120 causes the vehicle camera 961 to finish photographing based on the size of the golf ball in the image being photographed. Specifically, the photographing unit 120 finishes photographing when the golf ball comes to appear to be only about the size of a pixel of the vehicle camera 961.

The photographing unit 120 automatically detects that the user 20 has moved to the vicinity of a golf ball, or the user 20 has made a posture to shot. In this manner, it becomes unnecessary for the user 20 to make an instruction to start photographing by himself/herself, and there is an effect that it is possible to reduce the workload on the user, and to realize a more comfortable playing experience.

More specifically, the photographing unit 120 decides a timing from the skeleton-based action pattern (registered trademark) of the user 20 as a timing to start photographing. In this case, it is preferable for the photographing unit 120 to learn habit of the user, such as a pre-shot routine, and to optimize the photographing timing by using an AI (artificial intelligence). By equipping the course travelling vehicle 100 with an AI, and deciding the posture at the start of a shot, there is an effect that the amount of transmission data to the server device 200 can be reduced. Further, there is an effect that the load of image processing on the side of the server device 200 can be reduced.

Further, when there is a practice swing earlier, the photographing unit 120 may delete the practice swing part from an image to be transmitted as the trajectory image 52. In this manner, there is an effect that the amount of transmission data to the server device 200 can be further reduced. Furthermore, there is an effect that the load of image processing on the side of the server device 200 can be further reduced.

Deciding the posture at the start of a shot using the AI as described above may be performed by the server device 200.

Further, the photographing unit 120 controls the position of the course travelling vehicle 100 so that the vehicle camera 961 photographs the trajectory of a golf ball from behind the user 20 along the golf course 400. The photographing unit 120 generates photographing position control information to photograph the trajectory of the golf ball from behind the user 20 along the golf course 400, and transmits the photographing position control information generated to the movement control unit 110.

As illustrated in FIG. 6, the direction of a shot on the golf course 400 shall be B. The photographing unit 120 controls the position of the course travelling vehicle 100 and the direction of the vehicle camera 961 so that the trajectory of the golf ball is photographed toward B direction from behind the user 20. In this manner, there is an effect that trajectory analysis can be performed more precisely.

### <Trajectory Prediction Process: Step S102>

In Step S102, the trajectory prediction unit 210 of the server device 200 calculates the trajectory of the golf ball by using the trajectory image 52, as a predicted trajectory 61. Specifically, by analyzing the trajectory image 52 and the rider radar data, the trajectory prediction unit 210 traces the trajectory of the golf ball, and calculates the trajectory of the golf ball as the predicted trajectory 61.

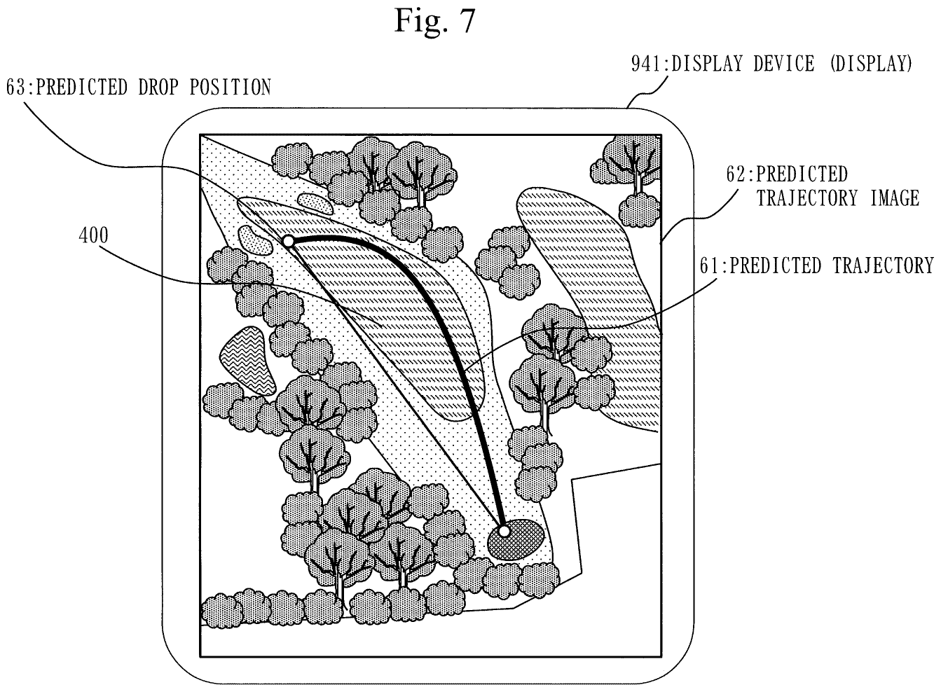

FIG. 7 is a diagram illustrating a display example of a predicted trajectory image 62 according to the present embodiment.

The trajectory prediction unit 210 generates the predicted trajectory image 62 obtained by superimposing the predicted trajectory 61 on the image of the golf course 400. Then, the trajectory prediction unit 210 displays the predicted trajectory image 62 on a display device.

The display device to display the predicted trajectory image 62 by the trajectory prediction unit 210 is at least either of the display device 941 mounted on the course travelling vehicle 100 or a portable terminal device carried by the user 20.

Specifically, the trajectory prediction unit 210 transmits the predicted trajectory image 62 to the course travelling vehicle 100, an apparatus such as a smartphone, a tablet computer and a smart watch carried by the user 20. Then, the predicted trajectory image 62 is displayed on the display of the course travelling vehicle 100, and on a display of the apparatus such as the smartphone, the tablet computer or the smart watch carried by the user 20.

### <Travelling Route Calculation Process: Step S103>

In Step S103, the route calculation unit 220 of the server device 200 calculates a predicted drop position 63 being a drop position of the golf ball by using the predicted trajectory 61. Then, the route calculation unit 220 calculates a travelling route 50 to the predicted drop position 63.

The route calculation unit 220 transmits the travelling route 50 to the course travelling vehicle 100.

The storage unit 250 of the server device 200 stores course map information 251.

The course map information 251 is high-precision three-dimensional map data used in automatic driving.

The course map information 251 records a past travelling performance of a course travelling vehicle in the golf course 400.

The route calculation unit 220 generates the travelling route 50 so that the number of times of travelling on the same route in the golf course 400 becomes equal to or smaller than the number of times determined beforehand (frequency threshold value 252), based on the course map information 251.

Further, in the course map information 251, an entry prohibited area of the course travelling vehicle in the golf course 400, a so-called Geo-Fence, is set. Geo-Fence is also called GeoFencing.

The entry prohibited area is set for an area such as a fairway, a rough and a bush. For example, in the course map information 251, a hazard area, a construction area, a maintenance area such as a ferment part of lawn, or the like that varies from day to day is set as the entry prohibited area, in addition to a normal cart entry impossible area.

The route calculation unit 220 generates the travelling route 50 so as to travel outside of the entry prohibited area based on the course map information 251. In this manner, a virtual fence is set in the golf course 400.

It may be possible to change the setting of a travelable area of the course travelling vehicle 100 between a case in which the course travelling vehicle 100 is a PMV (on which a person rides) and a case in which the course travelling vehicle 100 is an AMR (which only transports luggage). The travelable area of the AMR may be set broader than that of the PMV. This is because the AMR is considered to be unlikely to damage the lawn in comparison to the PMV, and the AMR is considered to be capable of travelling relatively safely even on a sloping ground since it does not allow a person to ride thereon.

Further, conversely, it may be possible to set the travelable area of the AMR narrower than that of the PMV in a case of carrying luggage heavier than a person, or unstable luggage.

As described above, high-precision three-dimensional map data of the golf course is set in the course map information 251.

The route calculation unit 220 generates the travelling route 50 so as to avoid a route with a steep slope based on the course map information 251.

By calculating the travelling route as described above, there is an effect that it is possible to reduce damage to the lawn due to travelling of the course travelling vehicle. Further, since the course is not damaged even when a plurality of course travelling vehicles travel, there is an effect that it is possible to provide a golfer with a comfortable playing experience as a result.

Furthermore, by setting the Geo-Fence, it is possible to prevent the course travelling vehicle from entering the entry prohibited area by mistake.

In addition, it is possible to prevent an area with a steep slope by referring to the high-precise three-dimensional map data of the golf course. Especially, there is an effect that it is possible to prevent an accident such as overturning of a vehicle due to crossing a sloping area, and to provide a golfer with a safe and comfortable playing experience on the golf course.

### <Automatic Driving Process: Step S104 to Step S105>

In Step S104, the movement control unit 110 of the course travelling vehicle 100 performs automatic driving in accordance with the travelling route 50 transmitted from the server device 200.

In Step S105, the movement control unit 110 of the course travelling vehicle 100 obtains position information 51 of the own vehicle by the position sensor 963 during automatic driving following the travelling route 50, and transmits the position information 51 to the server device 200.

The course travelling vehicle 100 obtains the position information 51 of the own vehicle also at the time when the course travelling vehicle 100 arrives at the predicted drop position 63, and transmits the position information 51 to the server device 200.

### <Ball Search Process: Step S106 to Step S109>

In a ball search process, when the course travelling vehicle 100 arrives at the predicted drop position 63, the ball search unit 230 of the server device 200 determines a search area 53 to search for a golf ball based on the predicted drop position 63. The ball search unit 230 searches for the golf ball by transmitting the search area 53 to the course travelling vehicle 100, and photographing the search area 53 with the vehicle camera 961. Then, the ball search unit 230 displays a search result 57 obtained by search on a display device.

Specifically as follows.

In Step S106, the ball search unit 230 determines the search area 53 to search for the golf ball based on the course map information 251 and the predicted drop position 63. For example, the ball search unit 230 determines an area within a radius of k meters (for example, k is within a range of 3 to 5) around a center of the predicted drop position 63 as the search area 53. The radius k can be arbitrarily set. Further, the ball search unit 230 may refer to a weather database, obtain information of wind, and set the search area 53 broader in a direction in which the wind blows. Furthermore, when there is a valley or a pond within a radius of k meters, an area before the valley or the pond may be set as the search area 53.

The ball search unit 230 transmits the search area 53 determined to the course travelling vehicle 100.

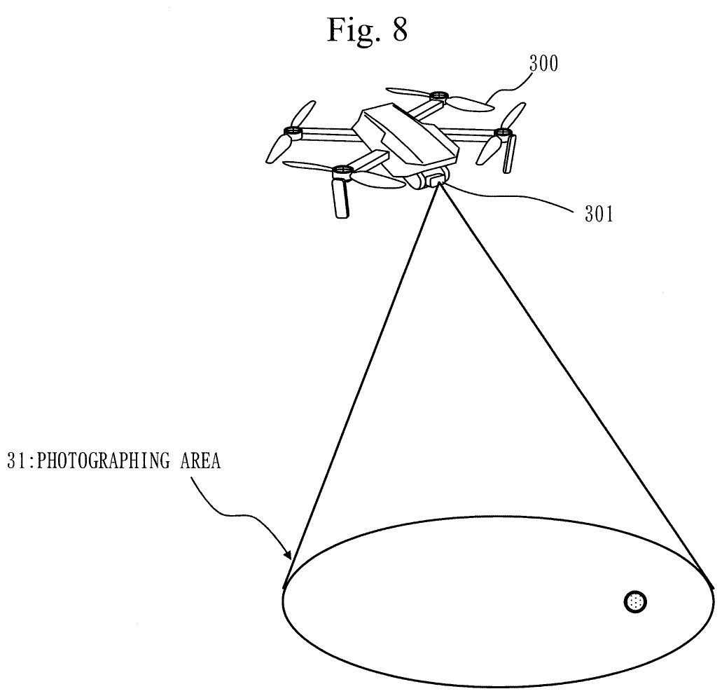

FIG. 8 is a diagram illustrating a situation of photographing by the drone 300 according to the present embodiment.

The ball search unit 230 determines whether there exists an area except for a fairway in the search area 53 based on the course map information 251. When an area such as a rough and a bush except for the fairway exists in the search area 53, there is a possibility that a golf ball may be hidden in a tall lawn or grass. When the golf ball is hidden, there is a possibility that the golf ball disappears and cannot be specified even when the search area 53 is photographed with the vehicle camera.

Then, when there is the area except for the fairway in the search area 53, it may be possible for the ball search unit 230 to easily specify the golf ball by photographing the search area 53 from above with the bird's-eye view camera 301 of the drone 300.

Specifically, when it is decided that there exists an area except for the fairway in the search area 53, the ball search unit 230 transmits the flight information 30 in order to photograph the search area 53 from above, and the photographing area 31 desired to photograph from above, to the drone 300. The drone 300 photographs the search area 53 from above in accordance with the flight information 30 and the photographing area 31, and transmits a search image 54a obtained by photographing to the server device 200.

In Step S107, the photographing unit 120 of the course travelling vehicle 100 receives the search area 53 from the server device 200. The photographing unit 120 photographs the search area 53 with the vehicle camera 961. The photographing unit 120 transmits the search image 54 obtained by photographing the search area 53 to the server device 200.

In Step S108, the ball search unit 230 searches for a golf ball by performing an image recognition process on the search image 54 obtained by photographing the search area 53. When the search image 54a obtained by photographing the search area 53 from above is received from the drone 300, the ball search unit 230 searches for the golf ball by performing the image recognition process on the search image 54 and the search image 54a.

For example, the bird's-eye view camera 301 mounted on the drone 300 is an infrared camera, and the search image 54a is an infrared camera image. Since the golf ball after shot gets hot, the ball search unit 230 can specify the golf ball from the search image 54a. Further, it may be possible to specify the golf ball from the search image 54a by imparting a special mark to the ball, and using a recognition function that reacts to the special mark.

In Step S109, the ball search unit 230 generates a search result 57.

Specifically as follows.

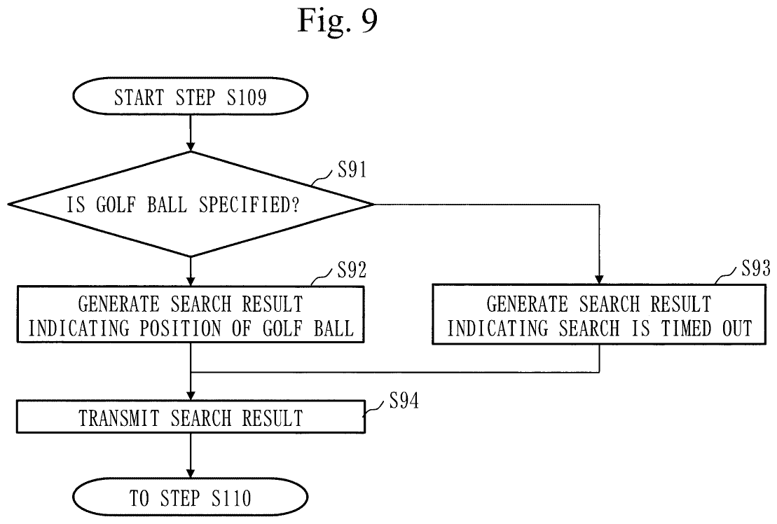

FIG. 9 is a flow diagram illustrating a drafting process of the search result 57 of the golf ball by the ball search unit 230 according to the present embodiment.

FIG. 9 is a detailed flow diagram of processing of Step S109 in FIG. 5.

In Step S91, the ball search unit 230 decides whether a golf ball is specified.

When the golf ball is specified, the procedure proceeds to Step S92.

When the golf ball is not specified, the procedure proceeds to Step S93.

In Step S92, when the golf ball can be specified, the ball search unit 230 specifies the position of the golf ball in the golf course by using the course map information 251. The ball search unit 230 generates a ball specification image in which the position of the golf ball is superimposed on the image of the golf course as the search result 57.

In Step S92, when the golf ball cannot be specified within a time determined beforehand, the ball search unit 230 generates an image representing that search of the golf ball has been timed out, as the search result 57.

In Step S93, the ball search unit 230 transmits the search result 57 to a display device.

In FIG. 5, the ball search unit 230 transmits the search result 57 to the course travelling vehicle 100.

Then, in Step S110, the display unit 130 of the course travelling vehicle 100 displays the search result 57 on the display device 941.

As with the predicted trajectory image 62, the search result 57 is also transmitted to the course travelling vehicle 100, a smartphone, a tablet computer or a smart watch or the like carried by the user 20. Then, the search result 57 is displayed on the display of the course travelling vehicle 100, a display of the apparatus such as the smartphone, the tablet computer or the smart watch carried by the user 20.

The user 20 is capable of searching for a ball in accordance with a ball specification image displayed on the display of the course travelling vehicle 100, the display of the apparatus such as the smartphone, the tablet computer or the smart watch carried by the user 20. In this manner, it is possible to reduce the time to search for a lost ball, and to realize smooth progress of the play; therefore, there is an effect that it is possible to provide a golfer with a comfortable playing experience.

Further, it is impossible to specify a golf ball when the golf ball goes out of the area where golfers can play, such that the golf ball drops in a valley or falls into a pond, the golf ball is hit into woods or the like. In this case, an image representing that search for the golf ball has been timed out is displayed on a display device. For example, it may be possible to display a notification that “The ball cannot be found. Let's continue playing from ‘Play Four (re-continue from the fourth shot from a special tee at the second stroke point)’!”. In this manner, it is possible to omit an unnecessary time to search for a lost ball, and realize smooth progress of the play; therefore, there is an effect that it is possible to provide a golfer with a comfortable playing experience.

This concludes the golf support processing according to the present embodiment.

In the present embodiment, the course travelling vehicle such as a PMV or an AMR has been used as an example of the moving body operated in the golf course. However, the moving body operated in the golf course may be another type of moving body.

For example, the moving body operated in the golf course may be an autonomous flying object like a drone. In this case, a photographing unit photographs a trajectory image by using a camera mounted on the autonomous flying object, and a route calculation unit calculates a moving route of the autonomous flying object to a predicted drop position, and transmits the moving route to the autonomous flying object.

### ***Other Configurations***

### <First Variation>

The course travelling vehicle may be equipped with a projecting device to project a projection mapping.

The ball search unit generates a projection mapping to guide a user in a direction of a position of a golf ball in a golf course, and transmits the projection mapping to the course travelling vehicle. In this case, the ball search unit generates the projection mapping to guide the user in the direction of the position of the golf ball based on a position and a posture of the course travelling vehicle at present.

The projecting device of the course travelling vehicle projects the projection mapping to guide the user on the golf course when receiving the projection mapping. For example, the photographing device projects an arrow toward the direction of the position of the golf ball from the course travelling vehicle on the lawn on the golf course.

According to First Variation, there is an effect that the time to search for a lost ball is shortened.

### <Second Variation>

The photographing unit of the course travelling vehicle photographs a condition of the golf course when the course travelling vehicle automatically drives to a destination. For example, the photographing unit has a function to decide whether the lawn is damaged. The movement control unit of the course travelling vehicle transmits information on a part where the lawn is damaged to the server device 200 while making the course travelling vehicle travel by avoiding the part where the lawn is damaged.

The server device 200 reflects the information on the part where the lawn is damaged in the course map information. Further, the server device 200 may generate a maintenance plan by using the information on the part where the lawn is damaged.

According to Second Variation, there is an effect that the golf course can be effectively maintained. Further, there is an effect that the maintenance cost can be reduced. Although description has been made herein by taking an example of the information on the part where the lawn is damaged, it may be possible to detect other change information on the course, such as hazard areas or construction areas by day.

### <Third Variation>

Further, the route calculation unit may set the travelling route to the vicinity of an area with a small amount of update data in the course map information. For example, in order to update the map data of an area during construction, a change area in the golf course, or a ferment area of lawn, it is necessary to measure the vicinity of these areas. The route calculation unit may set the travelling route to the vicinity of the areas that require these pieces of measured data.

The course travelling vehicle photographs the surroundings of the areas that require the measured data, and transmits the photographs to the server device 200 while automatically driving on the travelling route.

According to Third Embodiment, there is an effect that update data necessary for map update can be obtained.

### <Fourth Variation>

The server device 200 may collect data as follows, as detailed information of the golf course.
a) Image measured by a drone and point group data from the image
b) Rider radar data such as cart road data by the course travelling vehicle
c) Three-dimensional point-group information of the green by a drone or a fixed rider radar

### <Fifth Variation>

In the present embodiment, the drop position of a golf ball is predicted by analyzing the trajectory image. In this case, when the sun exists in the flying direction of the ball, the detection accuracy of the golf ball is degraded.

Therefore, when it is detected that the sun exists in the flying direction of the ball, the server device 200 devises the following.
1) Photograph a golfer side from a drop side by a drone or an AMR, and acquire a trajectory image obtained by photographing the golfer side from the drop side. By analyzing the trajectory image, even when there exists the sun in the flying direction of the ball, the prediction accuracy of the drop position is enhanced. In this case, the drone or the AMR is an example of the moving body operated in the golf course.
2) Make the course travelling vehicle photograph in conjunction with other course travelling vehicles, and make a plurality of course travelling vehicles photograph the trajectory of the golf ball. The trajectory prediction unit predicts the drop position of the golf ball from a plurality of trajectory images. In this case, it may be possible to perform interlocking control by inter-vehicle communication by the plurality of course travelling vehicles. Otherwise, it may be possible to transmit interlocking decisions to a plurality of course travelling vehicles from the server device.
3) The server device or the course travelling vehicle may have a structure to control a camera installed inside the course. It may be possible to separately photograph the golfer side from the drop side with the camera installed inside the course, and acquire the trajectory image obtained by photographing from the drop side to the golfer side. By analyzing this trajectory image, the prediction accuracy of the drop position is enhanced even when the sun exists in the flying direction of the ball.

### <Sixth Variation>

In photographing the trajectory image, it may be possible to set an angle of view so as to include an entire user as well as the golf ball so that the trajectory image can be utilized for swing analysis.

Otherwise, it may be possible to mount a plurality of cameras of a camera to photograph the trajectory of the golf ball and a camera to photograph a swing of the user on one course travelling vehicle.

### <Seventh Variation>

In the present embodiment, the functions of each device of the course travelling vehicle 100 and the server device 200 are realized by software. As a variation, the functions of each device of the course travelling vehicle 100 and the server device 200 may be realized by hardware components.

Specifically, each device of the course travelling vehicle 100 and the server device 200 include an electronic circuit 909 in place of the processor 910.

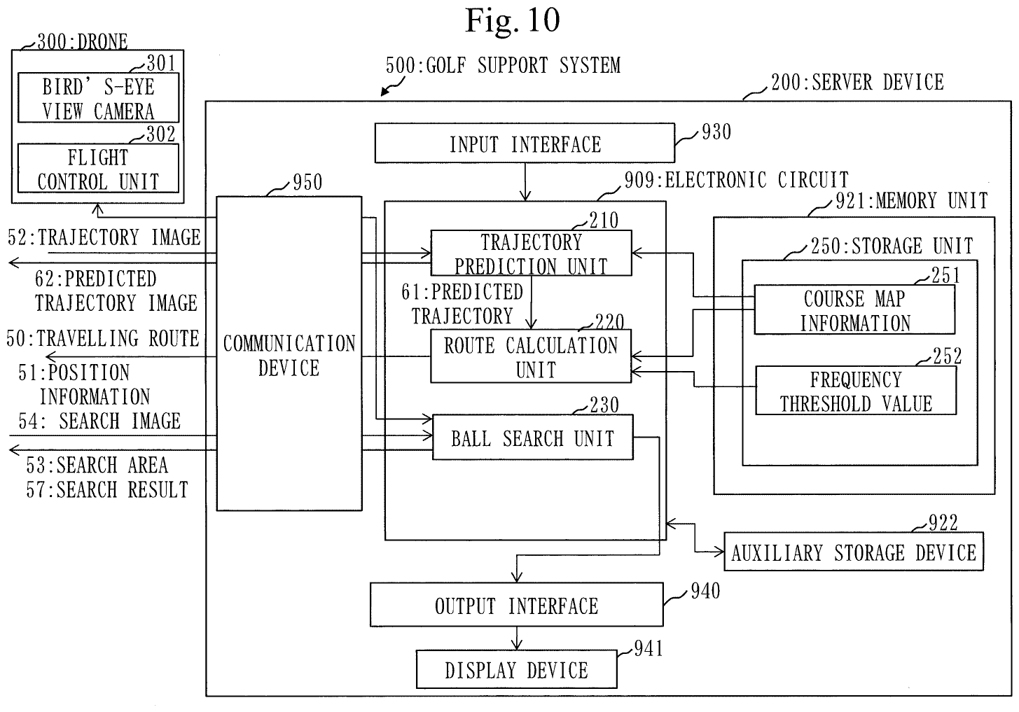

FIG. 10 is a diagram illustrating a configuration example of the server device 200 according to the variation of the present embodiment.

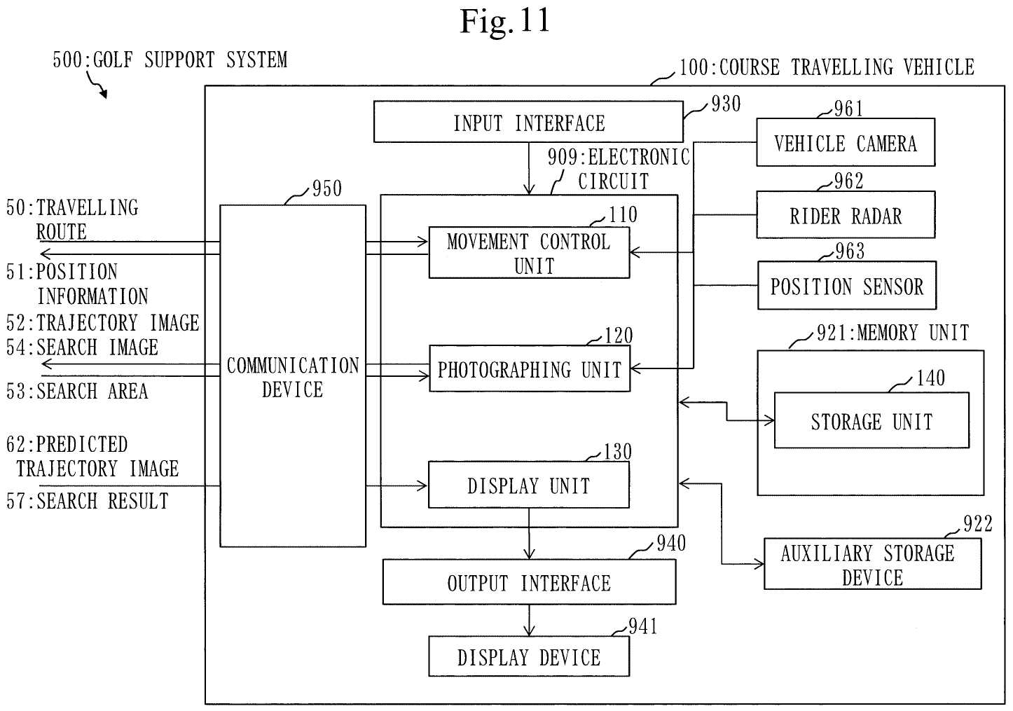

FIG. 11 is a diagram illustrating a configuration example of the course travelling vehicle 100 according to the variation of the present embodiment.

Hereinafter, description will be made by using the server device 200 as an example. The same is true of the course travelling vehicle 100.

The electronic circuit 909 is a dedicated electronic circuit to realize the functions of the trajectory prediction unit 210, the route calculation unit 220 and the ball search unit 230. The electronic circuit 909 is, for example, a single a single circuit, a composite circuit, a programmed processor, a parallel-programmed processor, a logic IC, a GA, an ASIC or an FPGA. GA is an abbreviation for Gate Array. ASIC is an abbreviation for Application Specific Integrated Circuit. FPGA is an abbreviation for Field-Programmable Gate Array.

The functions of the trajectory prediction unit 210, the route calculation unit 220 and the ball search unit 230 may be realized by one electronic circuit, or may be realized by a plurality of electronic circuits dispersedly.

As another variation, a part of the functions of the trajectory prediction unit 210, the route calculation unit 220 and the ball search unit 230 may be realized by an electronic circuit, and the remaining functions may be realized by software. Further, a part or all of the functions of the trajectory prediction unit 210, the route calculation unit 220 and the ball search unit 230 may be realized by firmware.

Each of the processors and electronic circuits is also called processing circuitry. That is, the functions of the trajectory prediction unit 210, the route calculation unit 220 and the ball search unit 230 are realized by processing circuitry.

### ***Description of Effect of Present Embodiment***

As described above, by the golf support system according to the present embodiment, it is possible to perform search and specification of the golf ball smoothly and appropriately by using the image photographed by the course travelling vehicle that automatically drives on the golf course. Therefore, it is possible to reduce the load on the user in searching for the ball, and to provide a comfortable playing experience.

Further, since the time to search for the ball is shortened, and the play is progressed smoothly, there is an effect of attracting customers thanks to the improvement of the turnover rate.

Further, by to the golf support system according to the present embodiment, the server device manages positions of the plurality of course travelling vehicles, and manages histories of the travelling routes of the plurality of course travelling vehicles. Therefore, by the golf support system according to the present embodiment, it is possible to realize improvement in course maintenance by using a threshold value of the travelling frequency at the same place, and by minimizing overlapped travelling on the same root or in a rotating place.

Furthermore, by the golf support system according to the present embodiment, it is possible to manage information such as a track on which travelling is overlapped, an intersection, frequency, and whether the vehicle is manned or unmanned, as the course travelling information, with respect to the plurality of course travelling vehicles. In addition, by managing those pieces of course travelling information, it is possible to visualize and display the travelling condition of the course by changing colors, etc. on the map.

Then, lastly, it is possible to utilize the course travelling information as maintenance information for the course inside the fairway. For the course, hardness to some extent is said to be necessary, and the degree of hardness of the course is also said to be know-how for making courses. The hardness of the course is generated by aggressive travelling of a lawnmower, a golf cart, a carriage of caddie bags or the like. The course travelling information can be utilized as the maintenance information for the course inside the fairway at the time.

### Second Embodiment

Description will be made mainly on points different from First Embodiment, and points added to First Embodiment.

In the present embodiment, components having functions similar to those in First Embodiment are denoted by the same reference signs, whereof description is omitted.

In a present embodiment, the course travelling vehicle 100 transmits a user image 55 obtained by photographing a state of the user 20 on the golf course to the server device 200.

In the server device 200, the user information provision unit 240 provides a user with various services by analyzing the user image 55.

### ***Description of Configuration***

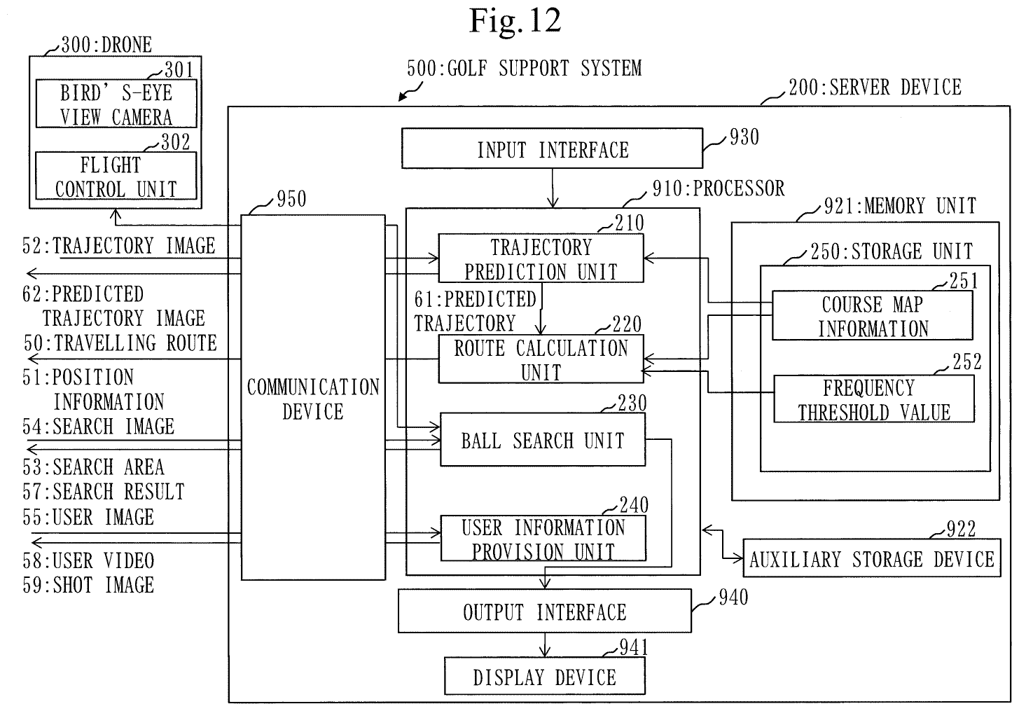

FIG. 12 is a diagram illustrating a configuration example of the server device 200 according to the present embodiment.

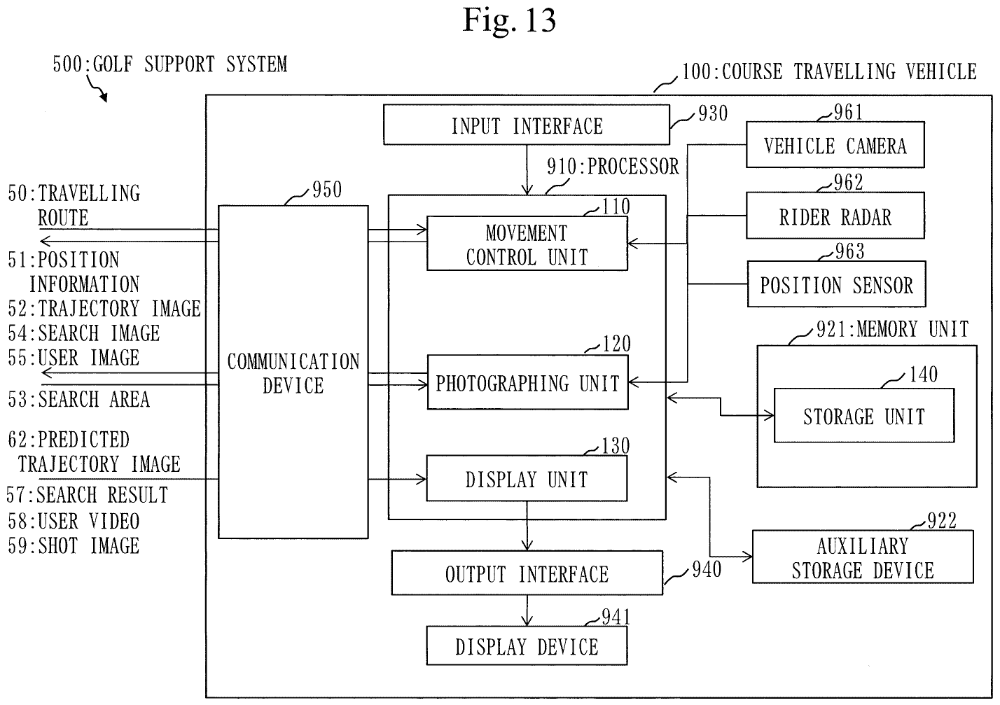

FIG. 13 is a diagram illustrating a configuration example of the course travelling vehicle 100 according to the present embodiment.

The server device 200 includes a user information provision unit 240 in addition to the functional elements in First Embodiment.

The user information provision unit 240 obtains a state of the user 20 on the golf course as a user image 55. The user information provision unit 240 generates a user video 58 that summarizes play of the user, or a shot image 59 of the user based on the user image 55.

A basic configuration of the course travelling vehicle 100 is similar to that in First Embodiment.

The photographing unit 120 photographs a state of the user during play, and transmits the photograph to the server device 200 as the user image 55.

The display unit 130 receives the user video 58 or the shot image 59 from the server device 200, and displays the user video 58 or the shot image 59 on the display device 941.

### ***Description of Operation***

### <Shot Image>

The user information provision unit 240 photographs the condition of the user 20 on the golf course with the vehicle camera 961 as the user image 55. The user information provision unit 240 extracts a shot image of a shot of the user 20 photographed from the user image 55, and displays the shot image on a display device as the shot image 59 representing a swing of the user 20. The display device here is a display of the course travelling vehicle 100, a display of an apparatus such as a smartphone, a tablet computer or a smart watch carried by the user 20.

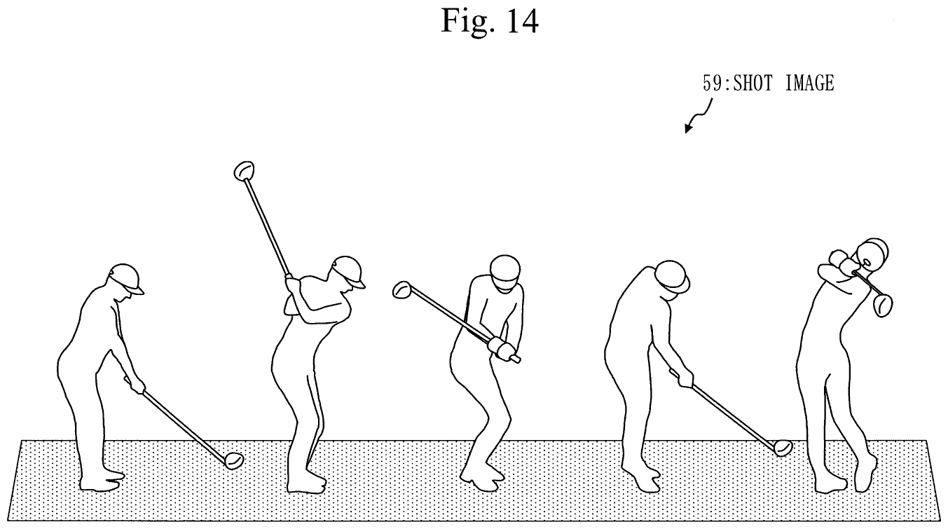

FIG. 14 is a diagram illustrating an example of the shot image 59 according to the present embodiment.

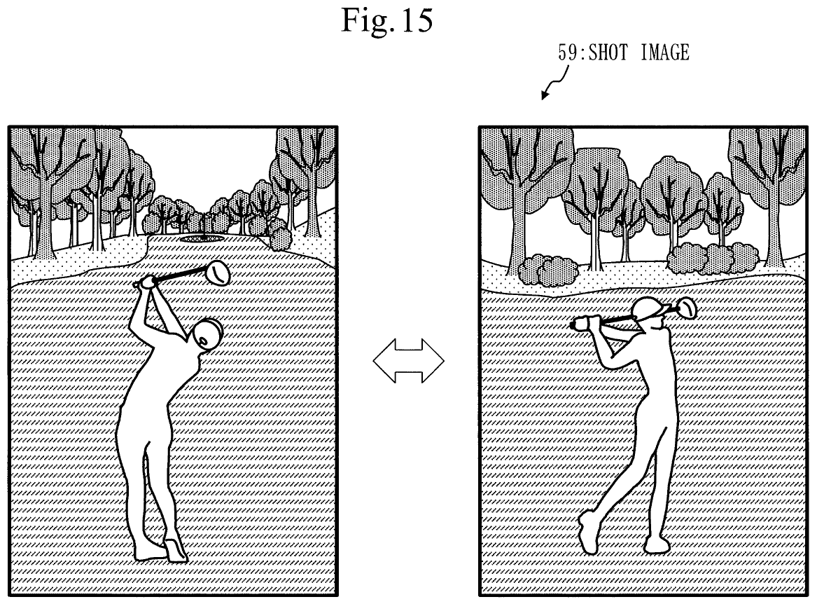

FIG. 15 is a diagram illustrating another example of the shot image 59 according to the present embodiment.

The user information provision unit 240 provides shot images 59 in a consecutive format from swinging back to follow-through as illustrated in FIG. 14, in response to a request by the user.

Further, the user information provision unit 240 may provide the shot image 59 at the time of swinging in accordance with a request by the user, as illustrated in FIG. 15. Furthermore, the user information provision unit 240 may photograph a swing of a user from a different angle in corporation with another course travelling vehicle, a drone, another AMR, or another apparatus such as a camera inside the course.

The user information provision unit 240 learns various golf swings, decides a state of a golf swing appropriately, and provides the user with the shot image 59, by using an AI.

### <User Video>

Additionally, the user information provision unit 240 generates the user video 58 that summarizes play of the user 20 on the golf course based on the user image 55. The user information provision unit 240 displays the user video 58 on a display device.

For example, the user information provision unit 240 extracts a topic for each hole from the user image 55, and generates a user video 58 on the play of all the holes. For example, the user information provision unit 240 may select a tee shot or a putt as a topic for each hole, and generate the user video 58.

The user information provision unit 240 learns a taste of the user along with the state of various plays in one hole, decides a state of a play appropriately, and provides the user video 58 preferred by the user, by using an AI.

### ***Other Configurations***

### <Eighth Variation>

In the present embodiment, the user image obtained by photographing the state of the user on the golf course is transmitted to the server device 200. In the server device 200, the user information provision unit provides the user with various services by analyzing the user image.

It may be possible to generate not only a video during the play (play video) but also a video summarizing clips until a golf competition. Further, it may be possible to make an album extracted from the user images, not a video.

### <Ninth Variation>

Further, it may be possible to add an additional value of an AI caddie or a remote lesson to the shot video.

The user information provision unit detects a start of shot from the user image, and generates lesson information at the time of shot. The user information provision unit generates lesson information as follows and transmits the lesson information to the course travelling vehicle by using three-dimensional information of the course, and information on comparison between undulations and swings, and the like.
Golf lesson (also called round lesson) (automatized comments by an AI and lessons performed remotely)
   Example: “Downhill lie. Ball position to the right, keep your swing compact, and swing along the slope . . . .”
   Example: “Last time, there was ○○. Be careful.”
   Example: “○○ yards to the hole cup. There is a green side bunker ΔΔ yards to the right. There is a deep bunker on the left around the green . . . .”

Further, the user information provision unit reads an expression of a user resulted from provision of lesson information by using a confirmation function of facial information by a smartphone, a tablet terminal or the like placed in the course travelling vehicle, and figures out whether “comfortable or uncomfortable”. In this manner, it may be possible to evaluate the lesson information provided.

It may be possible to put a user video and the like on a website when allowed by the user, and have the user evaluate the user video and the like. For example, it may be possible to allow the user to evaluate the user video and the like in the form of a simple questionnaire without burdening on the user. By collecting the evaluations, improvement in creating quality of the user videos is intended.

### <Tenth Variation>

It may be possible to provide an online golf competition system in which a plurality of people (for example, four players) play on physically different golf courses. The online golf competition system provides functions as follows, for example.
Hold a 4-person meeting (web conferencing). Hold a competition-member meeting (web conferencing).
Face authentication of players (confirm whether comfortable or uncomfortable, and utilize the confirmation for quality improvement)
Replay most recent shot form
Share scores

### <Eleventh Variation>

The course map information includes high-precision three-dimension map data of the green in the golf course. By using this high-precision three-dimension map data of the green, it is possible to provide a user with putting information to present a direction and a strength of a most suitable putting from a position of a golf ball on the green.

Further, by measuring a hole cup position in the green beforehand using not high-precision three-dimensional map data of the golf support system, but a high-precision satellite positioning terminal, e.g., a GPS positioning terminal, by registering the position in the course map information 251 as a private reference point, and by photographing an image of a ball on the green surface and the hole cup in one screen by the user, it is possible to provide the user with putting information through generating and utilizing high-precision three-dimensional information of the green surface from the image and the high-precision three-dimensional position information of the hole cup.

For example, the user is provided with the putting information as follows.
(1) Start an application on a mobile information terminal
(2) Photograph an image of a green surface including a golf ball
(3) Input speed of a ball rolling on the green surface beforehand. The rolling amount of ball is measured with a stimpmeter on the golf course (8 to 13 ft.).
(4) Provide an ideal putting line and strength (leveling conversion, etc.)

Further, it may be also possible to utilize new high-precision three-dimensional point group information that can be generated by utilizing images photographed by a smartphone or the like and information of a private reference point for registered “automatic update of high-precision three-dimensional point group information on the green surface”.

### ***Description of Effect of Present Embodiment***

As described above, by the golf support system according to the present embodiment, there is an effect that it is possible to provide various services to the user by analyzing the user images.

In First Embodiment and Second Embodiment above, each unit of each device of the golf support system is described as an independent functional block. However, the structure of each device of the golf support system may not be the structure as in the embodiments described above. The functional blocks of each device of the golf support system may have any configuration if only the functional blocks can realize the functions described in the embodiments described above. Further, each device of the golf support system may be a system configured by a plurality of devices, not by one device.

For example, a part of the functions of the server device 200 may be included in the course travelling vehicle 100. Otherwise, a part of the functions of the course travelling vehicle 100 may be included in the server device 200.

Further, a plurality of parts of First Embodiment and Second Embodiment may be combined and performed. Otherwise, a part of these embodiments may be performed. In addition, these embodiments may be combined partially or as a whole, and performed in any manner of combination.

That is, in First Embodiment and Second Embodiment, it is possible to freely combine each embodiment, to deform an arbitrary component of each embodiment, or to omit an arbitrary component in each embodiment.

The embodiments as described above are essentially preferable examples, and are not intended for limiting the scope of the present disclosure, the range of application of the present disclosure, and the range of use of the present disclosure. It is possible to variously change the embodiments described above as needed. For example, the procedures described using the flow diagrams and the sequence diagrams may be changed appropriately.

### REFERENCE SIGNS LIST

20: user; 30: flight information; 31: photographing area; 50: travelling route; 51: position information; 52: trajectory image; 53: search area; 54, 54a: search image; 55: user image; 57: search result; 58: user video; 59: shot image; 61: predicted trajectory; 62: predicted trajectory image; 63: predicted drop position; 100: course travelling vehicle; 110: movement control unit; 120: photographing unit; 130: display unit; 200: server device; 210: trajectory prediction unit; 220: route calculation unit; 230: ball search unit; 240: user information provision unit; 140, 250: storage unit; 251: course map information; 252: frequency threshold value; 300: drone; 301: bird's-eye view camera; 302: flight control unit; 400: golf course; 500: golf support system; 909: electronic circuit; 910: processor; 921: memory unit; 922: auxiliary storage device; 930: input interface; 940: output interface; 941: display device; 950: communication device; 961: vehicle camera; 962: rider radar; 963: position sensor

1.-21. (canceled)

22. A golf support system to support a user to play golf on a golf course, and to include a moving body to be operated in the golf course, the golf support system comprising:
processing circuitry
to photograph a trajectory of a golf ball hit by the user, by using a camera mounted on the moving body, as a trajectory image;
to calculate the trajectory of the golf ball by using the trajectory image, as a predicted trajectory;
to calculate a predicted drop position being a drop position of the golf ball by using the predicted trajectory, and to calculate a moving route of the moving body to the predicted drop position, and
to determine, when the moving body arrives at the predicted drop position, a search area to search for the golf ball based on the predicted drop position, to search for the golf ball by photographing the search area with the camera, and to display a search result obtained by search on a display device.

23. The golf support system as defined in claim 22, wherein the moving body is an autonomous delivery robot, a personal mobility vehicle (PMV) allowing a person to ride therein and to travel, or an autonomous flying object.

24. The golf support system as defined in claim 22, further comprising an autonomous flying object to autonomously fly over the golf course, and to include a bird's-eye view camera to photograph the golf course from above, wherein
the processing circuitry decides whether an area other than a fairway is included in the search area, and when the area other than the fairway is included in the search area, searches for the golf ball in the search area by photographing the search area with the bird's-eye view camera.

25. The golf support system as defined in claim 22, wherein the processing circuitry searches for the golf ball by performing an image recognition process on an image obtained by photographing the search area, and when the golf ball is specified, specifies a position of the golf ball in the golf course, generates the search result in which the position of the golf ball is superimposed on an image of the golf course, and displays the search result on the display device.

26. The golf support system as defined in claim 25, wherein the moving body includes a projecting device to project a projection mapping,
the processing circuitry generates the projection mapping to guide the user in a direction of the position of the golf ball in the golf course, and
the projecting device projects the projection mapping to guide the user on the golf course.

27. The golf support system as defined in claim 25, wherein the processing circuitry generates, when the golf ball is not specified within a time determined beforehand, the search result indicating that search for the golf ball has been timed out, and displays the search result on the display device.

28. The golf support system as defined in claim 22, further comprising a memory to store courses map information to record a past travelling history of the moving body in the golf course, wherein
the processing circuitry generates the moving route so that the number of times of travelling on a same route in the golf course is equal to or smaller than a predetermined number of times, based on the course map information.

29. The golf support system as defined in claim 28, wherein an entry prohibited area of the moving body in the golf course is set in the course map information, and
the processing circuitry generates the moving route so that only an area outside the entry prohibited area is travelled, based on the course map information.

30. The golf support system as defined in claim 28, wherein three-dimensional map data of the golf course is set in the course map information, and
the processing circuitry generates the moving route so as to avoid a route with a steep slope, based on the course map information.

31. The golf support system as defined in claim 22, wherein the processing circuitry controls autonomous movement of the moving body, generates photographing position control information to control a position of the moving body so as to photograph with the camera the trajectory of the golf ball from behind the user along the golf course, and transmits the photographing position control information.

32. The golf support system as defined in claim 22, wherein
the processing circuitry detects a posture of the user at start of a shot, makes the camera start photographing of the trajectory of the golf ball based on detection of the posture at the start of the shot, and makes the camera finish photographing based on a size of the golf ball in an image being photographed.

33. The golf support system as defined in claim 22, wherein the display device is at least any of a display mounted on the moving body, and a mobile terminal device carried by the user.

34. The golf support system as defined in claim 22, wherein the processing circuitry displays on the display device a predicted trajectory image obtained by superposing the predicted trajectory on an image of the golf course.

35. The golf support system as defined in claim 22, comprising a server device to communicate with the moving body, wherein
processing circuitry of the moving body transmits the trajectory image to the server device,
processing circuitry of the server device calculates the predicted trajectory, calculates the moving route of the moving body, displays the search result, and transmits the moving route of the moving body to the moving body.

36. A non-transitory computer readable medium storing a golf support program used in a golf support system to support a user to play golf on a golf course, and to include a moving body to be operated in the golf course, the golf support program causing a computer to perform:
a photographing process to photograph a trajectory of a golf ball hit by the user as a trajectory image by using a camera mounted on the moving body;
a trajectory prediction process to calculate the trajectory of the golf ball as a predicted trajectory by using the trajectory image;
a route calculation process to calculate a predicted drop position being a drop position of the golf ball by using the predicted trajectory, and to calculate a moving route of the moving body to the predicted drop position, and
a ball support process to determine, when the moving body arrives at the predicted drop position, a search area to search for the golf ball based on the predicted drop position, to search for the golf ball by photographing the search area with the camera, and to display a search result obtained by search on a display device.

37. A golf support system to support a user to play golf on a golf course, and to include a course travelling vehicle to be operated in the golf course, and to transport a person or a piece of luggage, the golf support system comprising:
processing circuitry
to photograph a trajectory of a golf ball hit by the user, by using a camera mounted on the course travelling vehicle, as a trajectory image;
to calculate the trajectory of the golf ball by using the trajectory image, as a predicted trajectory, and
to calculate a predicted drop position being a drop position of the golf ball by using the predicted trajectory, and to calculate a moving route of the course travelling vehicle to the predicted drop position.

38. The golf support system as defined in claim 37, wherein the course travelling vehicle is a personal mobility vehicle (PMV) for a single passenger.

39. The golf support system as defined in claim 37, wherein the processing circuitry photographs a condition of the golf course when the course travelling vehicle travels in the golf course, and decides whether a lawn on the golf course is damaged.

40. The golf support system as defined in claim 39, wherein the processing circuitry controls autonomous movement of the course travelling vehicle, and controls the course travelling vehicle so that the course travelling vehicle travels by avoiding a part where the lawn is damaged.

41. The golf support system as defined in claim 39, further comprising
a server device to store course map information being map data of the golf course, wherein
the server device reflects information on a part where the lawn is damaged in the course map information.
